(19) United States
(12) Patent Application Publication
(10) Pub. No.: US 2008/0295896 A1
(43) Pub. Date: Dec. 4, 2008

(54) REMOVABLE AND REUSEABLE PIPE VALVE INSULATION WRAP

(76) Inventor: Dominic Maida, Newark, DE (US)

Correspondence Address: CONNOLLY BOVE LODGE & HUTZ, LLP, P O BOX 2207, WILMINGTON, DE, 19899, US

(21) Appl. No.: 11/755,772

(22) Filed: May 31, 2007

(51) Int. Cl. F16L 59/10; F16L 59/16

(52) U.S. Cl. 137/375

(57) ABSTRACT

In accordance with the present invention, a pipe insulation wrap comprises a flexible planar and generally rectangular sheet having opposite first edge portions and opposite second edge portions. A strip of double faced adhesive with a removable backer thereon is secured along one of the first edge portions for releasable attachment to the other first edge portion when the wrap is assembled around a pipe valve and its associated insulation and the backer is removed. Strips of double faced adhesive along the second edge portions, each with a removable backer thereon are releasably secured at opposite ends of the pipe valve and its associated insulation after removal of the backers on those strips.

### BACKGROUND OF THE INVENTION

The present invention relates to a pipe valve insulation wrap that is easy to remove and reapply when access to the valve is required.

Insulation around pipe valves is often destroyed when access to such valves is necessary for valve maintenance, repairs and the like. Once the insulation is removed it is often difficult to replace and the technicians working on these valves simple move on without replacement of the insulation.

### SUMMARY OF THE INVENTION

Accordingly, one of the objects of the present invention is a removable and reusable pipe valve insulation wrap that effectively maintains insulation material around the valve while allowing easy removal and reapplication of the insulation and wrap when access to the valve is required.

Another object of the present invention is a removable pipe valve insulation wrap which is simple in design and easy to manufacture.

Still another object of the present invention is a removable pipe valve insulation wrap which is uncomplicated to remove and reapply.

In accordance with the present invention, a pipe valve insulation wrap comprises a flexible planar and generally multi-sided sheet having opposite first edge portions and opposite second edge portions. A strip of double faced adhesive with a removable backer on the outside thereof is secured along one of the first edge portions, and strips of double faced adhesive each with a removable backer are secured along the opposite second edge portions, one strip along each second edge portion. The strip of double faced adhesive on one of the first edge portions of the sheet is adhesively secured to the other first edge portion after removal of its backer and wrapping of the sheet around pipe valve insulation. The opposite second edge portions of the sheet are adhesively secured to insulation adjacent a pipe valve after removal of the backers and wrapping of the sheet around the pipe valve insulation.

The pipe valve insulation wrap of the present invention is utilized in combination with a pipe valve having insulated pipes on opposite sides of the valve. Removable insulation is placed on the outside surfaces of the valve, and the flexible sheet is wrapped around the pipe valve insulation.

The strip of double faced adhesive on one of the first edge portions of the sheet is adhesively secured to the other first edge portion to secure the cover in place around the pipe valve and its insulation. The strips of double face adhesive on the opposite second edge portions of the sheet are adhesively secured to the insulated pipes on opposite sides of the valve.

### BRIEF DESCRIPTION OF THE DRAWINGS

Novel features and advantages of the present invention in addition to those mentioned above will be readily apparent to persons of ordinary skill in the art from a reading of the following detailed description in conjunction with the accompanying drawings wherein similar reference characters refer to similar parts and in which:

FIG. 1 is a top plan view of a removable and reusable pipe valve insulation wrap, according to the present invention;

FIG. 2 is a side elevational view of a standard pipe valve with insulated pipes connected to opposite ends of the valve;

FIG. 3 is a side elevational view similar to FIG. 2, but with a blanket of insulation being applied around the valve; and

FIG. 4 is a side elevational view of the pipe valve after complete application of the wrap around the valve and the blanket of insulation, according to the present invention.

### DETAILED DESCRIPTION OF THE INVENTION

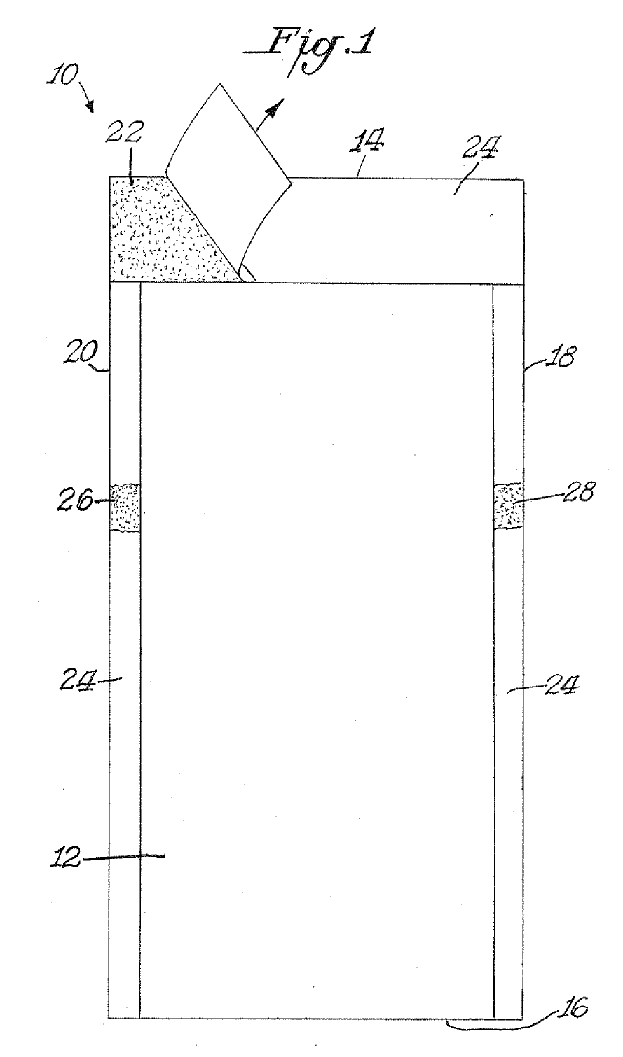

Referring in more particularity to the drawings, FIG. 1 shows a pipe valve insulation wrap 10 comprising a flexible planar and generally rectangular multi-sided sheet 12. The sheet has opposite first edge portions 14, 16 as well as opposite second edge portions 18, 20. Releasable fastening structure in the form of a double faced adhesive 22 is adhesively secured to one of the first edge portions 14 of the sheet. A removable backer 24 is secured to the adhesive strip 22. Also, double faced adhesive strips 26, 28 are secured to the second edge portions 18, 20 of the sheet, as shown in FIG. 1, and peel away removable backers 24 are secured to the strips 26, 28.

The sheet 12 may be fabricated from DuPont Tychem® QC which consists of a durable Tyvek® substrate quality coated with polyethylene. Rugged and durable, Tychem® QC is a tough barrier fabric that resists punctures and tears. Tychem® QC remains flexible even in cold conditions compared to other fabrics based on measurements over a wide range of temperatures. Tychem® QC is impermeable to water.

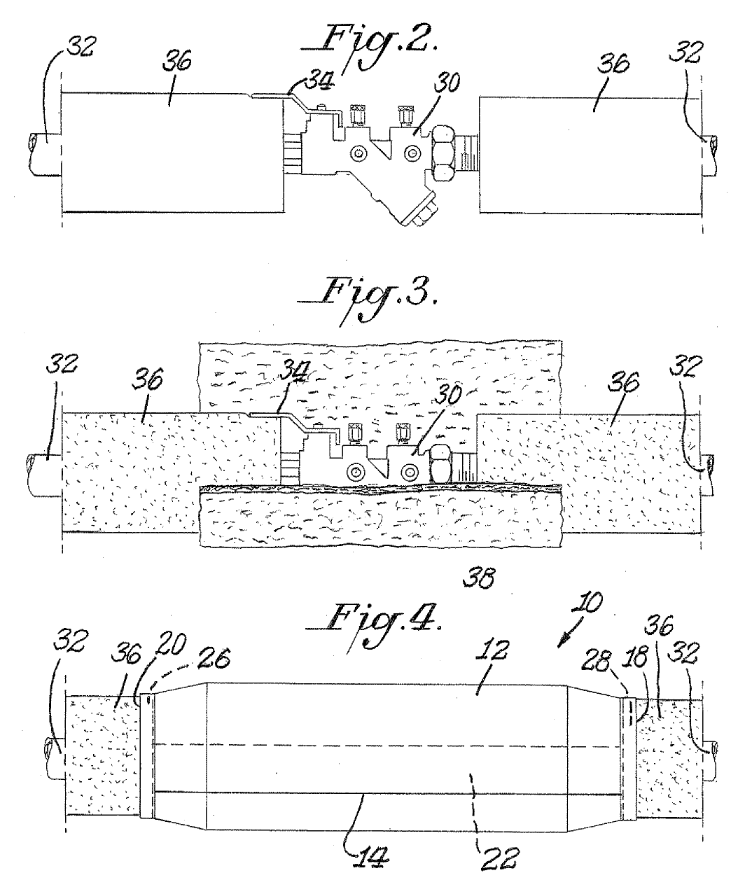

The pipe valve insulation wrap 10 of the present invention is used in combination with a pipe valve, such as ball valve 30 connected to pipes or tubing 32, as shown best in FIGS. 2 and 3. Valve 30 is illustrated as a simple in-line ball valve having a handle 34, but other valve configurations may also be utilized in combination with the insulation wrap 10. Insulation material 36 surrounds the pipes 32 while a blanket of similar insulation 38 is wrapped around the pipe valve 30 before being covered with the wrap 10.

With the blanket of pipe valve insulation 38 in place around the valve 30, the sheet 12 is simply wrapped around insulation 38 and the backer 24 is removed from the adhesive strip 22. The adhesive strip 22 is then pressed against the opposite edge portion 18 of the sheet. At the same time or immediately thereafter the backers 24 are peeled away from the adhesive strips 26, 28 along the second edge portions 18, 20, and these portions of the sheet are adhesively secured to the insulation 36 on the pipes 32.

The pipe valve insulation wrap 10 of the present invention functions to maintain the insulation 38 around the pipe valve 30 at all times. However, when adjustment and/or other servicing of valve 30 is required, both the wrap 10 and the insulation are easily removed from their positions around valve by separating the adhesive strips 22, 26, 28 from the sheet portions to which they are secured. Upon completion of such service, the insulation blanket 38 is simply positioned around the pipe valve 30, and the wrap 10 is then applied around the insulation, as described above. The wrap tightly surrounds the insulation 38 and the wrap is secured along the first edge portions 14, 16 of the sheet 12 by adhesive strip 22. The wrap is also secured to the insulated pipes 32 on opposite sides of the valve 30 by the adhesive strips 26, 28.

The valve wrap 10 is ideally suited for indoor or outdoor use on domestic water, chilled water, dual temperature, hot water, and steam along with other piping systems in commercial, institutional and industrial applications. Use on all outdoor vertical pipe applications of the wrap 10 may be additionally sealed using a white matching PVC tape or equal, for example,

What is claimed is:

1. A pipe valve insulation wrap in combination with a pipe valve and separate and removable insulation on outside surfaces of the pipe valve, the insulation cover comprising a unitary flexible planar and generally imperforate multi-sided sheet having opposite first edge portions and opposite second edge portions, a strip of double faced adhesive with a removable backer on the outside thereof secured along one of the first edge portions, strips of double faced adhesive each with a removable backer thereon secured along the opposite second edge portions one strip along each second edge portion, and wherein the flexible imperforate sheet is wrapped around the separate and removable insulation on outside surfaces of the pipe valve, and the strip of double faced adhesive on one of the first edge portions is releasably secured to the other first edge portion after removal of the backer, and the strips of double faced adhesive along the opposite second edge portions are releasably secured at opposite ends of the pipe valve.

2. The combination of claim 1 wherein the multi-sided sheet is rectangular.

3. The combination of claim 1 wherein the valve is a ball valve.
